(19) United States
(12) Patent Application Publication
(10) Pub. No.: US 2025/0236116 A1
(43) Pub. Date: Jul. 24, 2025

(54) INKJET PRINTING UNIT FOR CARDS AND RELATED PRINTING METHOD

(71) Applicant: MATICA FINTEC S.P.A., Milano (IT)

(72) Inventors: Valerio CIMBRO, Milano (IT); Pier FRANCESCUTTI, Milano (IT)

(21) Appl. No.: 18/698,547

(22) PCT Filed: Mar. 30, 2022
(86) PCT No.: PCT/IT2022/050073

§ 371 Date: Apr. 4, 2024

(30) Foreign Application Priority Data
Oct. 13, 2021 (IT) 102021000026270

(51) Int. Cl. B41J 11/00; B41J 2/165; B41J 3/54; B41J 13/12; B41J 25/304; B41J 29/17

(52) U.S. Cl. CPC B41J 11/00214; B41J 2/16507; B41J 3/54; B41J 13/12; B41J 25/304; B41J 29/17; B41J 2002/16594

(57) ABSTRACT

Some embodiments relate to an inkjet printing unit for cards is described, which comprises a transport system with a transport device for the cards through the printing unit, a first inkjet printing head that moves between a rest position and a printing position, a second inkjet printing head that moves between a rest position and a printing position, wherein the first and second printing heads work independently and are activated to print in the same or different zones to make it possible to print elements, each with a different ink, or combined; a printing method for cards with this inkjet printing unit is also described.

### CROSS-REFERENCE TO RELATED APPLICATIONS

This application is a national phase filing under 35 C.F.R. § 371 of and claims priority to PCT Patent Application No. PCT/IT2022/050073, filed on Mar. 30, 2022, which claims the priority benefit under 35 U.S.C. § 119 of Italian Patent Application No. 102021000026270, filed on Oct. 13, 2021, the contents of which are hereby incorporated in their entireties by reference.

### BACKGROUND OF THE INVENTION

### Field of the Invention

The present invention refers, in general, to an inkjet printing unit and to a printing method for cards, for example bank cards, identity documents or the like.

### Background Art

In the art, groups and printing methods for cards are known, for example cards with a CR 80 format or cards according to the ISO 7810 standard, in which a surface of paper is printed after being treated to make the surface more receptive to ink.

These known printing groups and methods have problems regarding quality of the printing process, ease of use for the end user, risks of machine downtime and in general overall efficiency of the system.

### SUMMARY OF THE INVENTION

Object of the present invention is solving the aforementioned prior art problems, by providing an inkjet printing unit for cards and a related printing method which are reliable and economical, and which allow the cards to be printed with a high quality, ease of use, reducing the risk of machine downtime.

The aforementioned and other objects and advantages of the invention, as will appear from the following description, are achieved with an inkjet printing unit and a related printing method for cards such as those described in the respective independent claims. Preferred embodiments and non-trivial variations of the present invention are the subject matter of the dependent claims.

It is understood that all attached claims form an integral part of the present description.

It will be immediately obvious that innumerable variations and modifications (for example relating to shape, dimensions, arrangements and parts with equivalent functionality) can be made to what is described, without departing from the scope of the invention as appears from the attached claims.

### BRIEF DESCRIPTION OF THE DRAWINGS

The present invention will be better described by some preferred embodiments thereof, provided by way of non-limiting example, with reference to the attached drawings, in which:

FIG. 1 is a schematic view of an inkjet printing unit for cards according to the present invention; and

FIGS. 2-4 are views of details of an inkjet printing unit for cards according to the present invention.

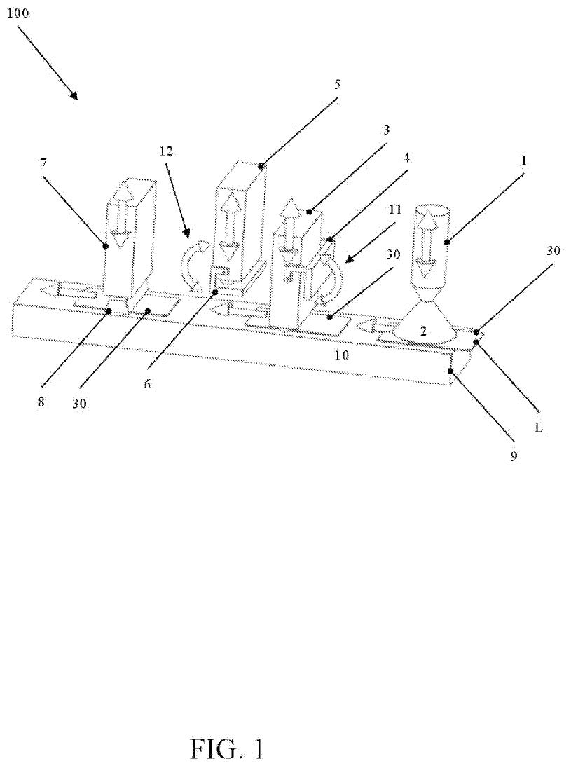

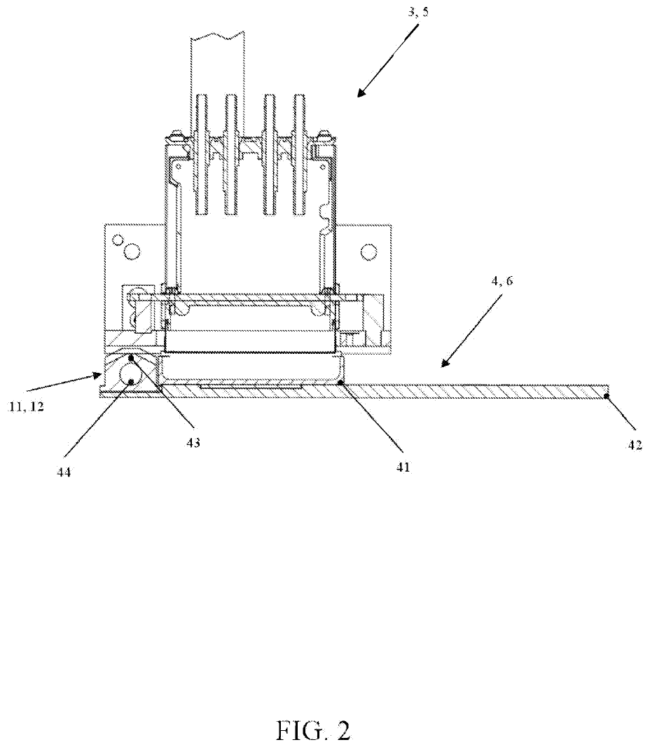

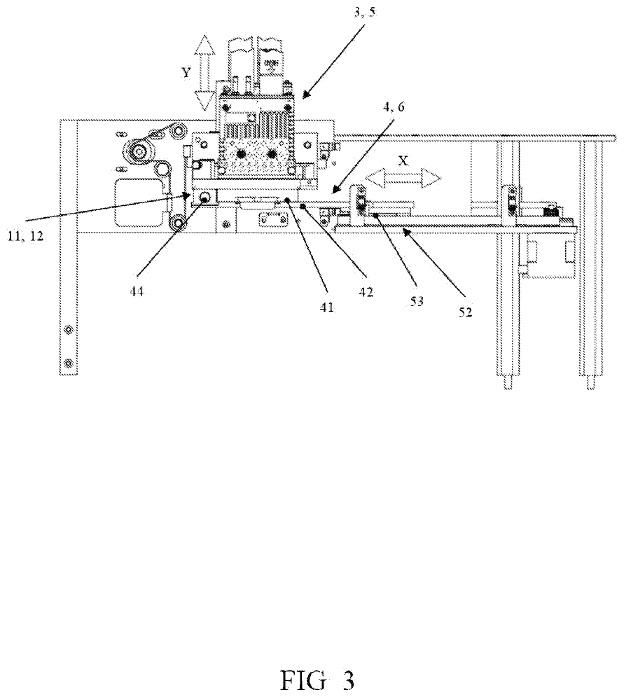

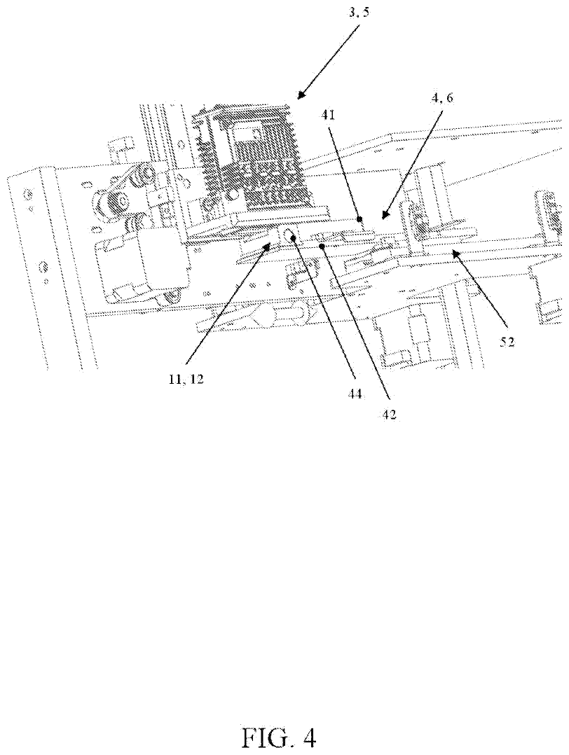

### DETAILED DESCRIPTION OF PREFERRED EMBODIMENTS

Referring to the Figures, the inkjet printing unit 100 for cards 30 according to the present invention comprises:
a transport system 9 comprising at least one transport device, preferably several independent associated transport devices, which manage several cards at the same time, configured to move the cards 30 through the printing unit 100 and preferably comprising a plurality of side rollers with clutch acting on the edge of the paper 30 and/or a shuttle with air suction, moved for example by a screw motor and comprising a paper presence sensor and a vacuum sensor; the side rollers allow not to touch the surface of the cards to be printed so as not to contaminate it, while the shuttle includes a surface for supporting the lower part of the cards and a vacuum system that ensures the retention of the cards in position during transport and during treatments;
a first inkjet printing head 3, configured to automatically move between a rest position, in which it is protected from dust and light by a first automatic protection device 4, and a print position, in which, after having moved the protection device 4, for example by rotating it, to move it away from the first head 3, it is brought closer to the paper 30 to print using a pigmented or transparent ink; for example, the first automatic protection device 4 is a movable or rotatable cover so as to move from a position in which it protects the first printing head 3, in particular the nozzles, to a position in which the protection device 4 is moved away from the first printing head 3, which is therefore free to move into the print position;
a second inkjet printing head 5, configured to move automatically between a rest position, in which it is protected from dust and light by a second automatic protection device 6, similar to the first automatic protection device 4, and a printing position, in which it is approached to the paper 30 for printing using a pigmented or transparent ink; the first 3 and the second 5 printing heads work independently from each other and can be activated alternately in order to print in the same area or in different areas, using the same color or different colors, allowing to use a second color simultaneously with the first, to make it possible to print two or more elements, each with a different ink, or combine them to obtain intermediate shades or create a tonal scale.

The devices and systems included in the ink-jet printing unit 100 for cards 30 according to the invention are operated by drive means of a known type, comprising for example at least one electric motor, and driven by a control unit, also known, which is also configured to control the advancement speed of the paper 30 in the transport system 9.

The printing head 3, 5 is movable so as to adjust the printing position by moving away and approaching the paper 30 to be printed in order to effectively and automatically calibrate the position with respect to the paper 30, improving printing precision and reducing defects. The movement of the head in the rest position allows the automatic protection device 4, 6 and an optional automated cleaning station to be integrated into the inkjet printing unit 100 according to the invention, making it possible to manually clean the nozzles of the printing head 3, 4.

Each automatic protection device 4, 6, provided in a preferred embodiment of the inkjet printing unit 100 according to the invention, protects the respective printing head 3, 5 in the rest position, avoiding contamination of the nozzles of the printing head 3, 5 with the consequent blocking of the ink output itself, reducing printing imperfections and consequent downtime. Furthermore, in an embodiment of the invention which provides for the use of UV-curable ink, which will be explained later, the automatic protection device 4, 6 also acts as a screen for ambient light, preventing the slow drying process of ink present on the surface of the printing head 3, 5 when not in use.

The inkjet printing unit 100 for cards 30 according to the invention, in the embodiment which provides for the use of UV-curable ink, further comprises a polymerization unit 7 comprising an element for the emission of UV rays, for example a UV lamp, configured to cure the ink printed on the paper 30 so as to cover with the UV rays a polymerization area 8 having a width greater than or equal to one side L of the paper 30, which is perpendicular to the advancement direction of the paper 30 in the transport system 9 so as to polymerize the ink on the surface of the paper 30 with only the movement of the paper 30; the advancement speed of the paper 30 in the transport system 9 during polymerization determines the amount of radiation absorbed by ink, while the emission angle of the radiation by the element for the emission of UV rays, controlled by the control unit, determines the point energy concentration.

The element for the emission of UV rays emits energy at a wavelength, defined by the ink specifications, of about 400 nm, preferably of 395 nm in standard use.

The polymerization unit 7 is movable so as to adjust its position by moving away from and approaching the paper 30 to be treated to effectively calibrate, preferably automatically, the position of the element for the emission of UV rays with respect to the paper 30, and comprises means for regulating the intensity of the UV rays, for example ignition means with controlled voltage, and/or means for regulating the optical profile to create wide-range or focused emission windows which allow, together with the regulation of the position, to calibrate the exposure of ink printed on the paper 30 optimally.

During curing, the time between printing ink and curing determines the final print quality based on the time allowed for ink to spread over the paper 30, amalgamate or mix with ink of other colors, while the intensity of irradiation and the exposure time determine the correct polymerization and adhesion to the substrate of the paper 30 on which it is printed.

The inkjet printing unit 100 for cards 30, in a preferred embodiment of the invention, comprises a surface treatment unit 1, comprising an element for the surface treatment of the paper 30, for example an element for the plasma emission, such as a gas flame, an element for the surface treatment with corona effect or other known means, for the application of a “receptive” layer, said element for the surface treatment of the paper 30 being configured to treat, with a single linear movement pass of the paper 30 under the surface treatment unit 1, the surface of the paper 30 to be printed on an area 2 having a width substantially equal to a side L of the paper 30 which is perpendicular to the advancement direction of the paper 30 in the transport system 9; the surface of the paper 30 to be printed is treated with only the movement of the paper 30, while the surface treatment unit 1 remains stationary; in an alternative embodiment of the invention, the surface treatment unit 1 is also mobile.

The treatment of the entire surface of the paper 30 with a single passage with linear movement under the surface treatment unit 1 guarantees full control of the uniformity and intensity of treatment by simply varying the speed of passage of the cards, allowing to carry out a process of simple calibration.

The surface treatment unit 1 is movable vertically to adjust its position, moving away and approaching the paper 30 to be treated, allowing the plasma application cone to be adapted to the surface of the paper 30 to be treated, to compensate for any differences in thickness of the paper 30, and vary the intensity of the treatment itself.

Preferably, the inkjet printing unit 100 for cards 30 of the invention comprises an air suction and filtering unit 10 positioned next to the surface treatment unit 1, configured to effectively remove air in the treated area 2, filter and remove contaminants in order to expel clean air.

The air suction and filtering unit 10 makes it possible to secure the process by removing any toxic gases, making the work environment safe. A further option is given by the presence of an extractor to bring air outwards.

Preferably, the inkjet printing unit 100 for cards 30 of the invention comprises a first 11 and a second 12 automatic cleaning systems configured to remove ink residues, dirt particles or contaminants from the surface of the respective first 3 and second 5 printing heads during the different phases of use, typically before and after each print; for example, the cleaning system 11, 12 comprises a deformable element, which can be made of plastic material, which rubs the surface of the head in correspondence with the nozzles to clean it.

The cleaning system 11, 12 also provides for the possibility of ejecting “disposable” ink to help detach any residues, replacing it with ink that can be used for printing.

The inkjet printing unit 100 for cards 30 of the invention further comprises a plurality of paper presence sensors, preferably of the electromechanical and vacuum type, controlled by the control unit, to check the presence of the paper 30 in all sections of the printing unit 100, allowing to identify critical issues in the process and to interrupt it in the event of problems that could cause damage.

The inkjet printing unit 100 for cards 30 of the invention can be used individually or with a second group in series to offer printing functionality on both sides of the paper 30.

A preferred embodiment of an automatic protection device 4, 6 and a cleaning system 11, 12 of an inkjet printing unit 100 according to the invention will now be described.

The automatic protection device 4, 6 comprises a shelf 42 movable with respect to a support 52, preferably sliding with respect to the support 52 on guide means 53 in a transverse direction X, preferably perpendicular, with respect to the movement direction Y of the printing head 3, 5, so as to move from the protective position of the printing head 3, 5, in particular of the nozzles, when the head is in the rest position, to the position away from the printing head 3, 5 to allow said head to move freely in the printing position.

Preferably, the automatic protection device 4, 6 comprises a tray 41 for protecting the printing head 3, 5, in particular the nozzles, configured to protect it from light and dust and to collect any ink residues, said tray 41 being connected to the shelf 42 so that it moves with the shelf 42 from the protective position of the printing head to the position away from the printing head.

Preferably, the protective tray 41 has dimensions such as to cover the nozzles of the printing head 3, 5 when positioned in the protection position, following the movement of the movable shelf 42, in front of the nozzles of the printing head 3, 5 when this is in the rest position.

Preferably, the cleaning system 11, 12 of the printing unit 100 is connected to the shelf 42 so as to move with it in correspondence with the nozzles of the printing head 3, 5, preferably back and forth along the X direction in correspondence with the nozzles, when the head 3, 5 is in the rest position, and comprises a suction nozzle 43 connected to a hole 44, for example made on the wall of the hole 44, in turn connected for example by means of a tube to a vacuum pump configured to suck through the suction nozzle 43 residual ink from the printing head nozzles, typically before and after each print.

The printing method for cards according to the invention includes the following steps:
a step in which the paper 30 to be printed is loaded into the inkjet printing unit 100 via the transport system 9 which can handle single or multiple pieces;
an optional step in which the paper 30 to be printed is moved by the transport system 9 in the surface treatment unit 1 to receive on the surface to be printed a treatment aimed at cleaning and facilitating printing on the surface of the paper 30; preferably, the treatment of the surface of the paper 30 to be printed is performed with a single linear movement passage of the paper 30 under the surface treatment unit 1;
a step in which the paper 30 to be printed is transferred by means of the transport system 9 to the first printing head 3 and subsequently to the second printing head 5, where it is printed using one or two separate and independent colors;
a step in which the first 4 and/or the second 6 automatic protection device is moved away from the first printing head 3 and/or from the second printing head 5, which is therefore free to move into the print position;
a printing step in which the first printing head 3 and/or the second printing head 5 automatically moves from the rest position, in which it is protected by the automatic protection device 4, 6, in the print position, approaching the paper 30 to be printed;
an optional step of ink drying in the polymerization unit 7 which polymerizes the ink printed on the paper 30;
a step of expelling the printed paper 30 from the inkjet printing unit 100, performed by the transport system 9.

In a preferred embodiment, the printing method for cards of the invention comprises:
an optional step, performed at the end of the printing step, in which the first printing head 3 and/or the second printing head 5 moves to the rest position, in which it is protected by the automatic protection device 4, 6;
a cleaning step, which is carried out periodically, in which the automatic cleaning system 11, 12 removes ink residues, dirt particles or contaminants from the surface of the respective first 3 and second 5 printing heads during the different steps of use, typically before and after each printing stage.

Preferably, the steps of the printing method according to the invention are performed without interrupting the movement of the paper 30 between the subsequent steps.

Advantageously, the inkjet printing unit for cards and the printing method of the invention allow printing cards with a high quality, reliably and economically, with ease of use and reducing the risk of machine downtime.

1. An inkjet printing unit for cards which includes:
a transport system comprising at least one transport device configured to move the cards through the printing unit;
a first inkjet printing head configured to automatically move between a rest position, in which it is protected from dust and light by a first automatic protection device, and a print position in which it approaches the paper to carry out the printing;
a second inkjet printing head configured to automatically move between a rest position, in which it is protected from dust and light by a second automatic protection device, and a print position in which it approaches the paper for printing,
wherein the first printing head and the second printing head work independently of each other and are activated to print in the same area or in different areas to make it possible to print elements, each with a different ink, or combined,
wherein the inkjet printing unit further comprises a surface treatment unit comprising an element for the surface treatment of the paper configured to treat, with a single passage with linear movement of the paper under the surface treatment unit, the surface of the paper to be printed on an area having a width substantially equal to a side of the paper which is perpendicular to the direction of advance of the paper in the transport system, the surface of the paper to be printed being treated with the movement of the paper, while the surface treatment unit can remain stationary or move.

2. The Inkjet printing unit of claim 1, further comprising a curing unit configured to cure ink printed on the paper in a manner to cover a polymerization area having a width greater than or equal to one side of the paper which is perpendicular to an advancement direction of the paper in the transport system, so as to polymerize ink on the surface of the paper with only the movement of the paper (30).

3. The inkjet printing unit of claim 2, wherein the polymerization unit includes an element for the emission of UV rays.

4. The inkjet unit of claim 1, wherein the first automatic protection device and the second automatic protection device, provided to protect the respective first printing head and second printing head, are a mobile cover so as to move from a position in which it protects the first printing head to a position in which the protection device is away from the printing head, which is then free to move into the print position.

5. (canceled)

6. (canceled)

7. The inkjet printing unit of claim 1, wherein the element for the surface treatment of the paper is an element for the emission of plasma, such as a gas flame, or a corona effect surface treatment element.

8. The inkjet printing unit of claim 1, further comprising an air suction and filtering unit positioned next to the surface treatment unit, configured to remove air on the treated area, filter and remove contaminants to expel clean air.

9. The inkjet printing unit of claim 1, further comprising a first automatic cleaning system and a second automatic cleaning system configured to remove residues of ink, dirt particles or contaminants from the surface of the respective first printing head and second printing head.

10. The inkjet printing of claim 1, wherein the automatic protection device comprises a shelf movable relative to a support in a direction transverse to the movement direction of the printing head so as to move from the protection position of the printing head when the printing head is in its rest position, to the position away from the printing head to allow the head to move freely in the printing position.

11. The inkjet printing unit of claim 10, wherein the shelf slides on guide means in a direction perpendicular to the movement direction of the printing head.

12. The inkjet printing unit of claim 11, wherein the automatic protection device comprises a tray for protecting the printing head, in particular the nozzles, configured to protect it from light and dust and to collect any ink residues, the tray being connected to the shelf so as to move with it from the protection position of the head to the position away from the printing head.

13. The inkjet printing unit of claim 12, wherein the protective tray has such dimensions as to cover the nozzles of the printing head when positioned in the protective position, following the movement of the movable shelf in front of the nozzles of the printing head in the rest position.

14. The inkjet printing unit of claim 1, wherein the cleaning system is connected to the shelf, so as to move with it, in correspondence with the nozzles of the printing head when the head is in the rest position.

15. The inkjet printing unit of claim 14, wherein the cleaning system is connected to the shelf at the nozzles of the printing head so as to move with it back and forth along the direction transversal with respect to the movement direction of the printing head.

16. The inkjet printing unit of claim 15, wherein the cleaning system comprises a suction nozzle connected to a hole, in turn connected to a vacuum pump configured to suck ink residues from the nozzles of the printing head through the suction nozzle.

17. A printing method for cards with the inkjet printing unit of claim 1, the method comprising the following steps:
a step in which the paper to be printed is loaded into the inkjet printing unit via the transport system;
an optional step in which the paper to be printed is moved by the transport system into the surface treatment unit to receive on the surface to be printed a treatment aimed at cleaning and facilitating printing on the paper surface;
a step in which the paper to be printed is transferred through the transport system to the first printing head and subsequently to the second printing head, where it is printed using one or two separate and independent colors;
a step in which the first automatic protection device and/or the second automatic protection device is moved away from the first printing head and/or from the second printing head, which is therefore free to move into its printing position;
a printing step in which the first printing head and/or the second printing head automatically moves from the rest position, in which it is protected by the optional automatic protection device, in the printing position, approaching the paper to be printed;
an optional step of ink drying in the polymerization unit which polymerizes ink printed on the paper;
a step of expelling the printed paper from the inkjet printing unit, performed by the transport system.
